(19) United States
(12) Patent Application Publication
(10) Pub. No.: US 2009/0225023 A1
(43) Pub. Date: Sep. 10, 2009

(54) Panel With Non-volatile Display Media

(76) Inventors: Thomas H. Szolyga, Saratoga, CA (US); Rahul Sood, Calgary (CA); Mark Solomon, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/242,206

(22) Filed: Sep. 30, 2008

Related U.S. Application Data
(60) Provisional application No. 61/034,706, filed on Mar. 7, 2008.

(51) Int. Cl. G09G 3/34; G09G 3/20

(52) U.S. Cl. 345/107; 345/55

(57) ABSTRACT

Non-volatile image display media is used in a display panel system. Images selected by a user are displayed on the non-volatile image display.

### CROSS REFERENCE TO RELATED APPLICATIONS

This application claims the benefit of provisional patent application Ser. No. 61/034,706, filed Mar. 7, 2008, titled “Panel With Non-Volatile Display Media.”

### BACKGROUND

Consumers often desire to change or customize the appearance of their personal devices. For example, decals, stickers, and custom side panels are available for gaming computers and decorative covers are available for cellular phones. While these items allow a user to change the appearance of a device, they must be physically removed and replaced if the user desires to again change the appearance of the device. Some consumer products such as, for example, personal computers, include one or more decorative displays on an exterior surface. These displays may allow a user to change the color of the display for a custom look. Because these displays are constructed of volatile display media, such as liquid crystal, it is necessary to provide power to the display to maintain its appearance.

### BRIEF DESCRIPTION OF THE DRAWINGS

FIG. 1 is a perspective view of a personal computer tower featuring a panel constructed in accordance with an embodiment of the present invention;

FIG. 2 is a functional block diagram of a display panel system constructed in accordance with an embodiment of the present invention;

FIG. 3 is a cross section of non-volatile image display media used in the practice of one embodiment of the present invention;

FIG. 4 is a flow chart listing steps for displaying an image on a panel in accordance with one embodiment of the present invention; and

FIG. 5 is a schematic illustration of a selection interface used in practice of one embodiment of the present invention.

### SUMMARY

A display panel system for use on a device surface is provided. The panel includes, for example, a non-volatile image display media configured to be connected to the device surface, an image controller configured to address the image display media to display an image, and an image selection interface configured to communicate one or more images to a user of the device and to communicate a selected image to the image controller.

### DESCRIPTION

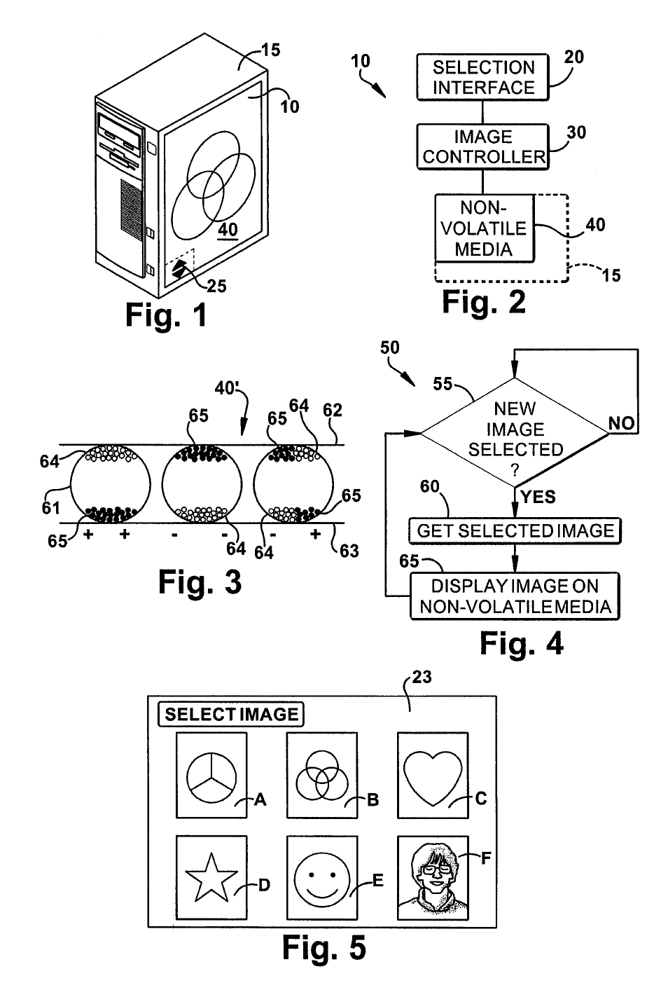

Referring to FIG. 1, a personal computer tower 15 is shown that includes a display panel system 10 that displays an image. In the described embodiment, the display panel system 10 is for decorative purposes, however, the display panel system 10 could also be used to communicate any information selected for display by a user of the personal computer tower. This information includes, for example, personal information about the user or user supplied images. In addition, the panel 10 may be used with any consumer device, such as, for example laptops, cellular phones, and personal data devices. The panel 10 may be installed on any exterior surface of a device, including computer towers, desktop computers, laptops, or peripheral devices such as a mouse or a monitor.

FIG. 2 is a functional block diagram of the display panel system 10. A selection interface 20 allows a user to select an image for display and communicates the selected image to an image controller 30 that alters the image displayed on non-volatile image display media 40 that is fixed to the computer tower 15 or other consumer device. The image controller may be implemented, for example, as a stand-alone hardware device that communicates with the CPU of the computer. The display panel system may include, or have access to, electronic storage that stores a plurality of images. These images may be provided by the manufacturer of the display panel system. The display panel system 10 may also include the capability for a user to store images for display in, for example, a jpeg or tiff file format.

The user interface 20 may be, for example, a software component (not shown) that generates a display 23 (FIG. 5) of one or more images A-E on a monitor associated with the computer tower. The software component registers selection of one of the images by a user via, for example, a keyboard or mouse. Alternatively, the user interface may permit a user to display an image that is presently on the computer's monitor, similar to a “print screen” function. In this manner, the user may display a scene from a game in which they are involved or a damage status or score screen associated with the game. The image controller 30 addresses the non-volatile image display media 40 to display the selected image. The image controller 30 may also automatically display pre-selected information related to computer status such as an amount of remaining memory, names of recently accessed files, or a representation of a display that was recently present on the monitor. When computer status information is displayed on the display panel system, it may be updated periodically when power is available to re-assign the image state of the display panel.

An alternative user interface 20 is a user actuable selector, such as toggle button 25. The toggle button may be implemented, for example, as a touch screen portion or overlay on the non-volatile display or as a mechanically actuable switch. The user may actuate the selector to display a different image on the non-volatile image display media 40.

The non-volatile image display media 40 is capable of maintaining its image state in the absence of power while being re-writable when power is supplied. This attribute allows the image to remain on display when the user is away from a power source without requiring battery back up. The non-volatile image display media 40 requires power when it is transitioning states to present a different image. The power used to transition can be provided by a consumer device's on board power supply or by a battery if the consumer device on which the panel display system is being used does not use power.

In a particular embodiment, the non-volatile image display media 40 is an electronic paper display 40′, a schematic cross section of which is depicted in FIG. 3. One source of electronic paper display is E-Ink Corporation of Cambridge, Mass. The electronic paper display may be glued or otherwise connected to an exterior surface of the consumer device. Electronic paper display includes microcapsules 61 encased between transparent top and bottom film electrodes 62, 63, respectively. Each microcapsule includes positively charged white particles 64 and negatively charged black particles 65 suspended in a clear fluid. In areas in which a negative electric field is applied between the electrodes 62, 63, the white particles 64 move toward the top electrode 62 while the black particles 65 move toward the bottom electrode 63. In areas where a positive electric field is applied, the black particles 65 move toward the top electrode 62 while the white particles mover toward the bottom electrode 63. When an electronic paper display 40′ is employed, the image controller 30 is operable to control the electric field across the electrodes 62, 63 to achieve the desired microcapsule states for display of the selected image. Of course, other non-volatile image display media, such a liquid crystal that includes pixels that are capable of maintaining their state in the absence of power can be used as part of the display panel system 10.

FIG. 4 is a flowchart outlining a method 50 that displays an image on the display panel system. At 55, the method detects whether a new image has been selected for display. If no new image has been selected, no action is taken. When a new image is selected at 60, the selected image is retrieved at 60 and displayed on non-volatile image display media at 65. As already discussed above, the image may be selected by displaying a plurality of images on a personal computing device monitor and registering an image selection from a user input such as a mouse or keyboard. Alternatively, the image may be selected by actuating a selector that causes a different image to be displayed. In this case the image retrieved by the method is the “next” image in a queue of stored images.

As can be seen from the foregoing description, the use of non-volatile image display media to display a user selected image on a surface of a consumer device provides a readily changeable and low power consuming display. While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. For example, various types of non-volatile image display media may be used to display user selected images. Therefore, the invention, in its broader aspects, is not limited to the specific details, the representative apparatus, and illustrative examples shown and described. Accordingly, departures may be made from such details without departing from the spirit or scope of the applicant's general inventive concept.

What is claimed:

1. A display panel system for use on a device surface comprising:
non-volatile image display media configured to be connected to the device surface;
an image controller configured to address the image display media to display an image; and
an image selection interface configured to communicate one or more images to a user of the device and to communicate a selected image to the image controller.

2. The display panel system of claim 1 wherein the non-volatile image display media comprises an electronic paper display.

3. The display panel system of claim 1 wherein the image controller comprises an electrode grid configured to energize non-volatile image display components to cause each component to assume a desired image state.

4. The display panel system of claim 1 wherein the image selection interface comprises a selection display configured to display one or more images for selection by a user.

5. The display panel system of claim 1 comprising electronic storage configured to store a plurality of images capable of display on the non-volatile image display media.

6. The display panel system of claim 5 wherein the image selection interface comprises an operator actuable selector configured to communicate one of the stored plurality of images to the image controller in response to actuation.

7. The display panel system of claim 6 wherein the operator actuable selector is disposed on the device surface to which the non-volatile image display media is connected.

8. The display panel system of claim 1 comprising a personal computing device having a housing that includes the device surface to which the non-volatile image display media is connected.

9. A method that displays an image on a device surface comprising:
receiving a selected image to be displayed, the image being selected by a user of the device; and
addressing non-volatile image display media to display the selected image.

10. The method of claim 9 comprising the step of providing a selection interface configured to present a plurality of images and to register selection of one of the images.

11. The method of claim 10 wherein the step of providing a selection interface is performed by displaying the plurality of images on a personal computing device monitor and registering selection of one of the images from a user input device associated with the computing device.

12. The method of claim 10 wherein the step of providing a selection interface is performed by providing a selection interface disposed on the surface, the selection interface responsive to operator actuation to display one of the plurality of images on the non-volatile image display media.

13. The method of claim 9 wherein the step of addressing non-volatile image display media is performed by selectively energizing portions of a grid wherein the grid is mapped to non-volatile image display components that change appearance based on a voltage applied to the component.

14. An apparatus for displaying an image on a device surface comprising:
electronic means for displaying an image, the means for displaying being capable of maintaining a present image state in the absence of power;
means for receiving a selected image that is selected by the user of the device for display on the electronic means for displaying; and
means for addressing the electronic means for displaying to cause the electronic means for displaying to display the selected image.

15. The apparatus of claim 14 wherein the electronic means for displaying an image comprises an electronic paper display.

16. The apparatus of claim 14 wherein the means for receiving a selected image comprises means for displaying a plurality of images and means for registering selection of one of the images.

17. The apparatus of claim 14 comprising image selection means disposed proximate to the device surface, the image selection means operable to display alternate selected images in response to actuation of the image selection means.

18. The apparatus of claim 14 wherein the means for addressing comprises means for selectively energizing a grid that is mapped to the electronic means for displaying an image.
